(19) United States
(12) Patent Application Publication
(10) Pub. No.: US 2021/0231698 A1
(43) Pub. Date: Jul. 29, 2021

(54) APPARATUS FOR ASCERTAINING A VELOCITY COMPONENT OF AN OBJECT

(71) Applicant: Air Profile GmbH, Kassel (DE)

(72) Inventors: Daniel Neuber, Wolfhagen (DE); Arthur Esch, Goettingen (DE); Paul Panin, Kassel (DE); Tobias Schellien, Kassel (DE)

(21) Appl. No.: 17/262,702

(22) PCT Filed: Jul. 22, 2019
(86) PCT No.: PCT/EP2019/069724

§ 371 Date: Jan. 22, 2021

(30) Foreign Application Priority Data
Jul. 23, 2018 (DE) 10 2018 117 776.3

(51) Int. Cl. G01P 3/36; G01P 5/26; G01S 17/50; G01S 7/481

(52) U.S. Cl. CPC G01P 3/36; G01S 7/481; G01S 17/50; G01P 5/26

(57) ABSTRACT

The invention relates to an apparatus for ascertaining a velocity component of an object that moves relative to the apparatus in a detection region at a measurement distance and that reflects light originating from a light source, the object generating reflected light that emanates from the detection region. To this end, the apparatus comprises an objective, a modulator, a reception optical unit and a light detector, wherein the objective detects the reflected light generated by the object in the detection region and elimages said light on the modulator, wherein the modulator modulates the reflected light into a sequence of light signals, wherein the reception optical unit images the sequence of light signals generated by the modulator on the light detector and wherein the light detector converts the sequence of light signals into a sequence of electronic signals. Further, the apparatus comprises an interface which transmits the sequence of electronic signals generated by the light detector to an evaluation unit.

### FIELD OF THE INVENTION

The invention relates to an apparatus for ascertaining a velocity component of an object that moves in a detection region at a distance relative to the apparatus and reflects light originating from a light source, wherein the object generates reflected light that emanates from the detection region.

### BACKGROUND OF THE INVENTION

Detection of the velocity of an object is necessary or desired in numerous fields of application, for example the velocity of a vehicle or person, the flow velocity of a liquid or the wind velocity at a specific height above the ground.

In the field of measuring wind velocities, a cup anemometer is often used. The latter consists of three or four hemispherical cups on a vertical rotary axle. It generates an electrical signal according to the resistance principle, and the wind velocity is calculated from said signal. An additional weathervane serves for ascertaining the wind direction.

So-called LiDAR systems (Light Detection And Ranging) have been developed for measuring wind velocities. The light emitted by a laser is reflected at air particles (aerosols) in the airflow and is received and evaluated by a measuring apparatus. A frequency analysis is used to determine the velocity of the aerosol and thus that of the wind. The accuracy of these instruments is sufficient only under certain physical assumptions and has to be verified by regular comparative measurements with reference measuring masts. An additional factor is that conventional LiDAR systems are unsuitable for detecting transverse velocity components.

In order to combat that, LiDAR systems that utilize the longitudinal Doppler effect have been developed. In order to ascertain a transverse velocity component, the laser is inclined by approximately 15° relative to its vertical axis and is rotated about this axis. The laser beam thus describes a measuring cone that is used to measure the longitudinal component of the wind velocity with respect to the laser beam and to calculate a mean value of the horizontal wind velocity therefrom. What is problematic here, however, is that the diameter of the measuring cone becomes ever larger with increasing height. An additional factor is that the measurements in greatly structured topographies (with hills, woodlands, valleys and buildings) are not sufficiently accurate.

EP 2 062 058 A1 proposes an apparatus for measuring a transverse velocity component with high spatial resolution, which is intended to be provided for distances of up to 500 m. A collimated laser beam is emitted in the direction of a detection region, the grating structure of a modulator being projected into the detection region. The movement of an object, for example of an air particle, through the projected grating structure in the detection region is detected by the apparatus as a periodic light-dark signal, from the frequency of which a transverse component of the wind velocity is calculated.

What is disadvantageous here is that a large portion of the laser power is absorbed by the modulator, with the result that an appropriately powerful laser has to be used. In order to detect both components of a transverse velocity, moreover, two measurements are required, wherein the modulator has to be rotated by 90°. The apparatus furthermore affords only limited possibilities for parameterization, as a result of which the adjustability to different measurement distances is made more difficult and the measurement accuracy is limited.

Problem Addressed by the Invention

The problem addressed by the invention is that of overcoming these and further disadvantages of the prior art and providing an apparatus for ascertaining a velocity component of an object which is constructed cost-effectively using simple means and enables an efficient as well as economic measurement of object velocities, in particular wind velocities at great heights. A high spatial resolution that is adaptable to the respective application and also a high measurement accuracy are furthermore striven for.

Solution to the Problem According to the Invention

The main features of the invention are specified in claim 1. Claims 2 to 15 relate to configurations.

The solution according to the invention provides an apparatus for ascertaining a velocity component, in particular a transverse velocity component, of an object that moves in a detection region at a measurement distance relative to the apparatus and reflects light originating from a light source, wherein the object generates reflected light that emanates from the detection region,
comprising a lens, a modulator, a receiving optical unit and a light detector,
wherein the lens captures the reflected light generated by the object in the detection region and images it onto the modulator,
wherein the modulator modulates the reflected light into a sequence of light signals,
wherein the receiving optical unit images the sequence of light signals generated by the modulator onto the light detector, and
wherein the light detector converts the sequence of light signals into a sequence of electronic signals, and
comprising an interface, which forwards the sequence of electronic signals generated by the light detector to an evaluation unit.

The apparatus thus captures the light reflected from an object, wherein the object for example a vehicle, a person, a drop of liquid, an aerosol particle, an aerosol, or the like moves through a detection region defined by the apparatus. This reflected light signal is imaged onto the modulator by the lens, is modulated by said modulator and is subsequently imaged onto the light detector as a sequence of light signals by means of the receiving optical unit. Said light detector thus detects a sequence of light intensity changes, from the frequency of which after the light signals have been converted into electronic signals the velocity of the object can be calculated by means of the evaluation unit.

The arrangement of the components of the apparatus according to the invention enables a compact construction that can be realized very much more cost-effectively than systems known hitherto. The apparatus is extremely robust and the modulator does not give rise to any disturbing interference. Rather, the sequence of light signals generated by the modulator can be modulated rapidly and conveniently on any received light reflection. It is possible to define the detection region at the distance from the apparatus in a simple manner using the lens. Moreover, the magnification of the grating pattern embodied on the modulator can be controlled by means of the focal length of the lens. A significantly higher light intensity of the incident reflected light and a correspondingly higher beam power simplify the detection of the sequence of light signals that is generated by the modulator and imaged on the light detector via the receiving optical unit. The apparatus can easily be reproduced because the calibration of the receiving optical unit is associated with little complexity. Furthermore, the apparatus offers a multiplicity of options for parameterization, as a result of which the apparatus can be designed rapidly and simply for a planned measurement distance. The production of the apparatus is thus extremely economic in comparison with conventional systems.

One embodiment of the invention provides for the lens, the modulator, the receiving optical unit and the light detector to be arranged on an optical receiver path. This enables an extremely compact and stable arrangement of the individual components, wherein it is further advantageous if the receiver path on which the lens, the modulator, the receiving optical unit and the light detector are arranged is embodied within the apparatus. The dimensions of the apparatus can be significantly reduced as a result.

In accordance with a further important configuration of the invention, the lens images the detection region with a defined depth of field on the modulator.

The lens serves to receive the light signals reflected from the object when the object moves through the detection region. The detection region is therefore defined by the lens by virtue of the measurement distance, i.e. the distance between the apparatus and the detection region, being defined by way of the focal length and the focus.

Catadioptric lenses are preferably used as the lens because they combine a long focal length with a short structural length. However, the choice of a suitable lens is not restricted to the type mentioned.

The depth of field of the lens defines the distance range over which the lens can image the object in the detection region, e.g. an aerosol particle, sharply onto the modulator. The depth of field range is usually delimited by a near point at a distance d, from the lens that is less than the measurement distance g, and a far point at a distance d_{f} from the lens that is greater than the measurement distance g.

The depth of field

h=d_{f}−dₙ (1)

thus results from the difference between the distance with respect to the far point

$${d}_{f} = \frac{g ( {d}_{h} - f )}{( {d}_{h} - f ) + ( f - g )} \qquad ( 2 )$$

and the distance with respect to the near point

$${d}_{n} = \frac{g ( {d}_{h} - f )}{( {d}_{h} - f ) + ( g - f )} \qquad ( 3 )$$

In the above, dₕ is the hyperfocal distance and f is the focal length of the lens and g is the measurement distance.

Thus, by way of the lens, the apparatus defines the detection region at a specific distance—the measurement distance, wherein the time range of the detected photons that is used for signal evaluation can be adapted depending on the depth of field h and the distances d_{f} and dₙ.

A further embodiment of the invention provides for the lens to image the light reflected from the object onto a defined region of the modulator. In this case, the modulator is preferably arranged in the focal plane, i.e. in the image plane of the lens.

In accordance with one development of the invention, the modulator is provided with a pattern of alternating opaque and non-opaque lines. These lines have defined widths bₒₚ and bₙₒₚ and are also referred to as a grating hereinafter.

The grating of the modulator is characterized by a basic grating constant G₀ given by the line spacing of two adjacent lines of identical type. The line widths bₒₚ and bₙₒₚ should be chosen such that the object to be observed is completely masked by an opaque line and is completely visible through a non-opaque line. The line widths should thus be dimensioned depending on the respective measurement task.

In the case of measurements of wind velocity, aerosol particles to be observed can be regarded as pointlike, such that the line widths can be chosen to be very small, down to a few micrometers. In the case of measurements of the velocity of extensive objects, e.g. vehicles, the line width has to be determined taking account of the maximum vehicle length and the measurement distance.

What is particularly advantageous is the embodiment of the modulator with a pattern of alternately opaque and non-opaque lines, wherein the opaque and non-opaque lines are embodied in the form of Archimedean spirals. If an orthogonal coordinate system having the axes x and y is assigned to the modulator, then it is possible to aim at two regions on the modulator, in which approximately parallel spiral lines run perpendicular to the x-axis and perpendicular to the y-axis, respectively. As a result, it is possible to modulate two different, preferably mutually perpendicular, directions of movement using only one modulator, particularly if the modulator is mounted rotatably about an axis.

In a simplified embodiment, the modulator is fixed within the apparatus.

Supplementarily or alternatively, the modulator can be arranged such that it is longitudinally displaceable along the optical receiver path.

A further configuration of the invention provides for the receiving optical unit to comprise a system of lens elements. The latter ensures the focusing of the sequence of light signals generated by the modulator onto the light detector, wherein the latter is arranged in the focal plane, i.e. in the image plane of the receiving optical unit.

The system of lens elements comprises at least one lens element, wherein the receiving optical unit can moreover have an optical filter and/or an iris stop. The iris stop serves for setting the diameter d_{Obj} of the detection region captured by the lens. The optical filter eliminates stray light from the surroundings that passes into the lens.

The diameter of the detection region d_{Obj}(g) is defined depending on the measurement distance g and the opening diameter b of the iris stop as follows:

d_{Obj}(g)=V(g)·b (4)

In the above,

$$V ( g ) = g \cdot ( \frac{1}{f} - \frac{1}{g} ) \qquad ( 5 )$$

describes the magnification of the field of the detection region at the measurement distance g for a lens having the focal length f.

The receiving optical unit can furthermore have a transmission region set to the wavelength of the light source; that is to say that the receiving optical unit affords the possibility of carrying out wavelength-specific filtering.

Depending on the application, the light detector is a photodetector or a photomultiplier, for example, which can register even light signals of very low intensity down to individual photons and convert them into electrical signals.

A further configuration of the invention provides for the signal generated by the light detector to be amplified. To that end, an amplifier can be provided, which is assigned either to the light detector, to the interface or to the evaluation unit.

A further important configuration of the invention provides for a beam splitter to be arranged between the lens and the modulator and to split the light reflected from the object into two partial beams.

In this case, the invention furthermore provides for the lens to image the partial beams generated by the beam splitter into a first region and into a second region of the modulator, wherein the regions do not overlap. Furthermore, the modulator modules the partial beams in a first and a second sequence of light signals, wherein the receiving optical unit images the sequence of the first light signals generated by the first region of the modulator onto the light detector, while a second receiving optical unit images the sequence of the second light signals generated by the second region of the modulator onto a second light detector.

The second receiving optical unit and the second light detector are preferably arranged on a second optical receiver path, wherein the receiver path and the second receiver path are arranged parallel.

It is thus possible to ascertain two transverse velocity components of an object, e.g. when measuring a windfield.

If, in addition, the modulator is rotated exactly once about its axis (rotation angle 360°), then each of the two regions is traversed exactly once by all spiral lines embodied on the modulator. If, moreover, the modulator is caused to rotate at a rotational frequency n, then the regions mentioned are traversed by the spiral lines at a frequency f₀=n·Nsₚ, wherein said lines move in the direction of the x-axis in the first region and in the direction of the y-axis in the second region—in a manner rotated by 90°.

The receiving optical unit arranged downstream of the modulator and the second receiving optical unit, each with a light detector disposed downstream, thus register a signal with the frequency f₀ in the case of a nonmoving object excited to backscattering. This frequency is therefore referred to as the zero frequency f₀.

While it is sufficient for numerous applications if the light source is a natural light source, such as the ambient light or sunlight, for example, a further important embodiment of the invention provides for the light source for the light to be reflected to be a laser or an incoherent light source.

For velocity measurements on relatively large objects, e.g. vehicles or persons, given sufficient illumination, e.g. by daylight, a separate light source is not required. However, if the lighting conditions are insufficient, i.e. if the light intensity on the receiver path is insufficient, an artificial light source can be used. This can be a laser or an incoherent light source.

A cw laser or an incoherent light source can be used, for example, for measuring the flow velocity of a liquid.

A pulsed laser is preferably used for measurements of wind velocity.

In order that the light emitted by the light source is incident on the object to be measured, a mirror optical unit is provided, which directs the light emanating from the light source in the direction of the detection region. In this case, it is advantageous, moreover, if the mirror optical unit directs the light emanating from the light source into the optical axis of the lens.

The invention furthermore provides for an imaging optical unit to be provided, which collimates the light emanating from the light source, wherein the imaging optical unit preferably comprises a system of lens elements.

The system of lens elements serves for shaping (expanding and collimating) the light signal generated by the light source. The system of lens elements is designed on the basis of the following relationship:

d(g)=d₀+g·φ (6)

The equation indicated describes the diameter of the laser beam d(g) depending on the measurement distance g, the diameter d₀ of the emergent laser beam after shaping and the divergence angle φ of this laser beam, which angle is determined by the system of lens elements.

In a further configuration of the invention, the light source, the imaging optical unit and the mirror optical unit lie on an optical transmission path. The latter thus serves for illuminating the detection region situated at the predefined measurement distance, such that a possibly moving object situated there is excited to backscattering of reflected light in the direction of the receiver path.

In a further embodiment of the invention, the transmission path and the receiver path are combined at the output of the apparatus upstream of the lens on an optical axis. This likewise contributes to an extremely compact design of the apparatus.

In specific applications, e.g. when measuring a vehicle velocity in daylight, the ambient light may already suffice to sufficiently illuminate the detection region. In such cases, the transmission path and the arrangement situated therein can be dispensed with.

In general, however, it is necessary to illuminate the detection region using a light source and the components on the transmission path.

For a compact embodiment of the apparatus, provision is furthermore made for the light source, the imaging optical unit and/or the mirror optical unit to be arranged within the apparatus.

In order that the signal generated by the light detector, namely the sequence of electronic signals generated from the light signals, can be processed further, the interface is provided. The latter is connected to the evaluation unit via a cable connection or via a radio link.

The evaluation unit, for example a computer or laptop, can be embodied outside and separately from the apparatus. In this case, the interface is connected to the computer or laptop via a cable. However, a radio link, for example an infrared connection or Bluetooth connection, can also be used.

However, the evaluation unit can also be part of the apparatus. In this case, the interface is preferably connected to the evaluation unit via a cable connection.

The evaluation unit expediently has a memory that stores the sequences of electronic signals generated by the light detector, wherein the evaluation unit calculates the velocity components of the object from the sequences of said electronic signals.

In the data memory of the evaluation unit, the temporal profile of at least one electrical signal is recorded and analyzed. Furthermore, the ascertained velocities stored as a function of time are displayed or communicated in electronic form to the user.

The performance of the apparatus according to the invention is substantially determined by the light source, the lens, the modulator and the photodetector, namely by their properties (parameterization).

A basis for this parameterization is formed by the LiDAR equation known from “Laser Remote Sensing”, ed.: Takashi Fujii, Tetsuo Fukuchi, CRC Press (2005), page 487, formula 7.2

$${P}_{S} = {η}_{t} \cdot {η}_{x} \cdot {E}_{x} \cdot O ( g ) \cdot {T}^{2} ( \frac{c β}{2} ) ( \frac{{A}_{R}}{{g}^{2}} ) \qquad ( 7 )$$

with the parameters explained in Table 1.

TABLE 1
Parameters of the LiDAR equation

| | |
|---|---|
| Pₛ | Gathered power via the aperture D of the lens |
| Eₓ | Pulse energy |
| ηₜ | Transmission losses |
| ηₓ | Reception losses |
| T | Atmospheric transmission losses |
| β | Backscattering coefficient of the observed object in the detection |
| | region |
| O(g) | Overlap function (of the laser beam with the detection region) |
| A_{R} | Area of the aperture D of the lens: A_{R} = (1/4)πD² |
| g | Distance from the lens to the detection region (= measurement |
| | distance) |
| c | Velocity of light in the medium (e.g. in air or a liquid) |

In the above, ηₜ and ηₓ are system-dictated constants, determined in particular by the systems of lens elements in the transmission path and receiver path. T, β, g, c are application-specific constants. If a plurality of measurement distances g are intended to be employed, then the largest measurement distance should be inserted into the LiDAR equation. O(g) describes the overlap of the cross section of the detection region with the cross section of the laser beam. An optimum overlap is assumed, which would correspond to O(g)=1. This value decreases to O(g)=0.5 since 50% of the power gathered by the lens is lost during passage between the modulator.

The use of the apparatus according to the invention during a wind measurement is manifested as follows:

At a selected location, at a predefined measurement distance, a detection region predefined by the lens is illuminated, preferably with collimated laser light, by the apparatus—which is equipped with a corresponding light source.

An object that is situated in said detection region or moves through the latter, e.g. an aerosol particle, is impinged on by the laser light. The object reflects the impinging light and thus generates reflected light that emanates from the detection region and impinges on the lens of the apparatus.

The lens focused onto the detection region images the reflected light onto a region of the preferably rotating modulator. The grating pattern thereof moves here at a frequency f₀ determined by the embodiment of the grating pattern and by the rotational frequency of the modulator. Illustratively, this process can be described as a backward projection of that region of the modulator which is being traversed by the backscattering signal into the detection region.

The grating pattern—composed of equidistant parallel opaque and non-opaque lines—is thus projected into the detection region situated at the measurement distance g, wherein said pattern is magnified to a grating constant G that is set such that the grating completely covers the detection region.

The following relationship holds true for the magnification V of the grating constant G:

G(g)=V(g)·G₀ (8)

If a stationary backscattering object is situated in the detection region, then it generates a signal with the zero frequency f₀ downstream of the modulator.

If the object moves at a velocity v through the x-y-plane, the frequencies measured by the photodetectors change to

fₓf₀+Δfₓ=n·N_{Sp}+vₓ/G (9)

f_{y}=f₀+Δf_{y}=n·N_{Sp}+v_{y}/G (10)

In this case:

Δfₓ=vₓ/G (11)

and

Δf_{y}=v_{y}/G (12)

are the frequency changes of the two partial signals relative to the zero frequency f₀.

It is possible to calculate from this, given a known grating constant G, directly the components vₓ and v_{y} of the velocity of the pointlike object in the x-direction and in the y-direction.

The frequency shifts Δfₓ and Δf_{y} are positive if the pointlike object has a velocity component vₓ and v_{y}, respectively, directed counter to the direction of movement of the spiral lines; they are negative if the pointlike object has a velocity component vₓ and v_{y}, respectively, directed in the same direction as the direction of movement of the spiral lines. Magnitude |v| and direction α of the velocity of the pointlike object are calculable from the velocity components vₓ and v_{y} in a known manner:

|v|=\sqrt{vₓ²+v_{y}²} (13)

α=arctan (v_{y}/vₓ) (14)

In this case, α, proceeding from the x-axis, is to be measured in the mathematically positive direction of rotation (in the counterclockwise direction).

In order that the apparatus according to the invention yields an unambiguous result for the wind velocity, it is additionally necessary to ensure that the conditions

f₀>|Δfₓ|, d.h. f₀>|vₓ|/G (15)

f₀>|Δf_{y}|, d.h.f₀>|v_{y}|/G (16)

are always met.

Furthermore, the following conditions should be complied with:

f₀+|Δfₓ|<PRF/2 (17)

f₀+|Δf_{y}|<PRF/2 (18)

The sum of the zero frequency and the magnitude of the frequency shift must be less than half the pulse repetition frequency in order to satisfy the Nyquist-Shannon sampling theorem.

If the wind direction is known, it is also possible to work with f₀=0, that is to say with a rigid modulator. The measurement then yields the magnitudes |vₓ| and |v_{y}| of the components vₓ and v_{y}, which is sufficient in this case.

If the object whose velocity is to be measured emits a sufficient amount of light, then its excitation by a light source is not absolutely necessary. It suffices to equip the apparatus exclusively with the components of the receiver path.

### DESCRIPTION OF THE DRAWINGS

In the exemplary embodiment below, an advantageous way of embodying the invention is explained with the aid of drawings, in which:

FIG. 1 shows a schematic illustration of an apparatus according to the invention for ascertaining a velocity component of an object;

FIG. 2 shows a schematic illustration of a modulator for the apparatus according to the invention for ascertaining a velocity component of an object; and

FIG. 3 shows a schematic illustration of another embodiment of an apparatus according to the invention for ascertaining a two-dimensional velocity vector of an object.

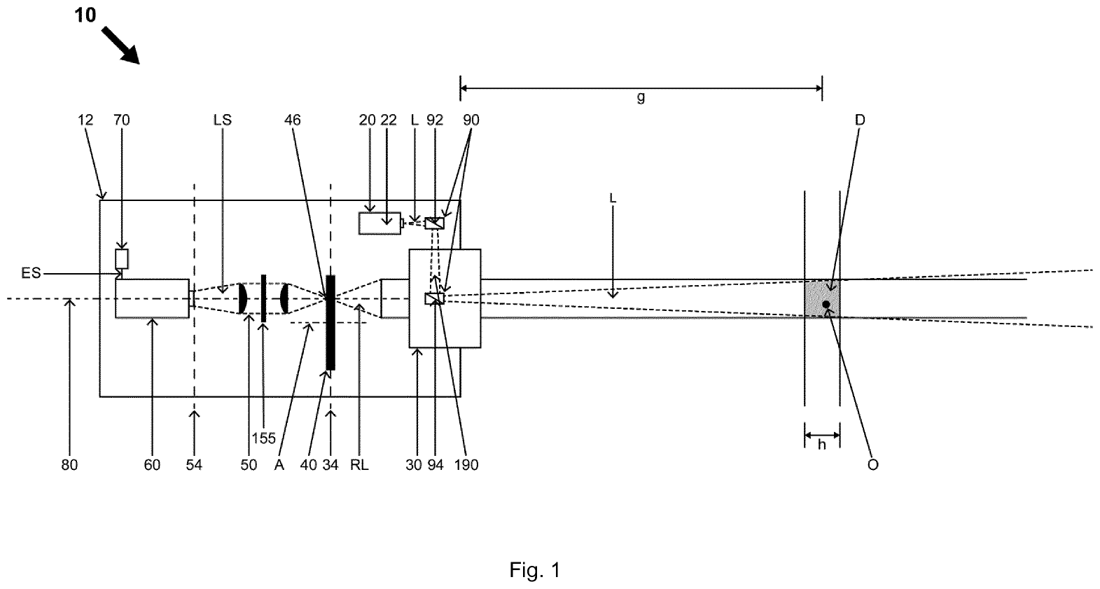

The apparatus designated generally by 10 in FIG. 1 is embodied as a LiDAR system and serves for wind measurement and thus for ascertaining a horizontal and/or transverse velocity component vₓ and/or v_{y} of an object O, namely of an aerosol particle, that is moving in a detection region D at a measurement distance g relative to the apparatus 10. The object reflects light L emanating from a light source 20 and in the process generates reflected light RL that emanates from the detection region D.

The wind measurement is preferably effected in a ground-based manner, i.e. the apparatus 10 is fixed on the ground and the measurement is carried out as vertical remote measurement, wherein the horizontal components vₓ and v_{y} of the wind velocity, i.e.

transverse components thereof relative to the incidence of light in the apparatus, are ascertained.

The apparatus 10 comprises the light source 20, a lens 30, a modulator 40, a receiving optical unit 50 and a light detector 60 in a housing 12. Furthermore, the apparatus 10 has an interface 70 between the light detector 60 and an evaluation unit (not illustrated). The lens 30, the modulator 40, the receiving optical unit 50 and the light detector 60 are arranged on an optical receiver path 80.

Besides the light source 20, the apparatus 10 also comprises a mirror optical unit 90 and an imaging optical unit (not shown) with a system of lens elements (likewise not illustrated). The light source 20, preferably a laser 22, the imaging optical unit and the mirror optical unit 90 lie on an optical transmission path 190.

It is evident in FIG. 1 that the laser 22, the mirror optical unit 90 and the imaging optical unit are arranged in the housing 12 of the apparatus 10 in such a way that the transmission path 190 and the receiver path 80 are combined at the output of the apparatus 10 and thus at the output of the LiDAR system upstream of the lens 30 on an optical axis. For this purpose, the mirror optical unit 90 has on the transmission path 190 a first deflection mirror 92 arranged in front of the laser 22, and also a second deflection mirror 94 positioned on the optical axis of the receiver path 80. The aperture of the lens 30 is distinctly larger than the dimensioning of the second deflection mirror 94, likewise lying on the receiver path 80.

The system of lens elements of the imaging optical unit comprises two converging lens elements, for example, and serves for expanding the laser beam L emitted by the laser 22 to a defined diameter and for subsequently collimating this beam. The collimated beam is emitted along the optical axis of the receiver path 80 in the direction of the detection region D with the aid of the deflection mirrors 92, 94. At a measurement distance of g=300 m, its diameter d that determines the horizontal spatial resolution according to equation (6) is 0.25 m, for example. If, for example, the overlap function O(g) is set to a value of O(g)=0.5 (for identical proportions of opaque and non-opaque regions 43, 44), then at the measurement distance g the diameter d of the laser beam L is equal to the diameter dab, of the detection region captured by the lens and is equal to the horizontal spatial resolution.

If the ratio between the proportions of opaque and non-opaque regions 43, 44 is chosen differently (deviating from a ratio of 1:1), the value of O(g) can also be greater or less than 0.5.

The laser 22 used as the light source 20 is a monochromatic pulsed laser having a wavelength of λ=532 nm, for example. Such a laser 22 is cost-effective and enables particularly simple adjustment of the LiDAR system 10. The further laser parameters should in each case be coordinated with the desired measurement distance g and the object to be measured, here aerosol particles.

The lens, for example a catadioptric lens, captures the reflected light RL generated by the object O in the detection region D and images it onto the modulator 40, wherein the reflected light RL is focused onto a selected first region 46 of the modulator 40.

If a lens 30 having an aperture D of 35.6 cm (14 inches), a focal length f of 3910 mm and an f-number k=f/D=11, then the values indicated in Table 2 result for the depth of field h. The parameters of the lens and the laser wavelength used are summarized in the right-hand column of Table 2.

TABLE 2
Depth of field depending on the object distance =
measurement distance g

| Object | Depth | |
|---|---|---|
| distance g [m] | of field h [m] | Focal length f [m] |
| 50 | 0.05 | 3.91 |
| 100 | 0.2 | Hyperfocal distance dₕ [m] |
| 150 | 0.45 | 97338.38 |
| 200 | 0.8 | Circle of least confusion Z |
| | | [mm] |
| 250 | 1.26 | 0.01 |
| 300 | 1.83 | f-number k |
| | | 11 |
| | | Wavelength λ [nm] |
| | | 532 |

The modulator 40 has on its surface a pattern 42 of opaque and non-opaque lines 43, 44 forming a grating. The lines 43, 44 are preferably spiral lines 41, particularly preferably in the form of Archimedean spirals. As a result, the light RL reflected by the object O, upon passing through the detection region D, is modulated into a sequence of light signals (LS) by the modulator 40.

Said sequence of light signals LS is imaged onto the light detector 60 by the receiving optical unit 50, said light detector correspondingly generating a sequence of electronic signals ES that are forwarded to the evaluation unit via the interface 70.

If the modulator 40 is stationary, i.e. if it is fixed in the housing 12, a velocity component vₓ of the detected object can be calculated from the detected electronic signals ES.

Preferably, however, the modulator 40, and thus the pattern 42, is arranged in a rotating manner in the housing 12, i.e. the pattern 42 of the modulator 40 is permanently rotated about an axis that is parallel to the receiver path 80. This gives rise to a defined line movement in a radial direction, which can be evaluated quantitatively. Two horizontal components vₓ, v_{y} of the velocity of the object O and thus a two-dimensional velocity vector can be ascertained in this way.

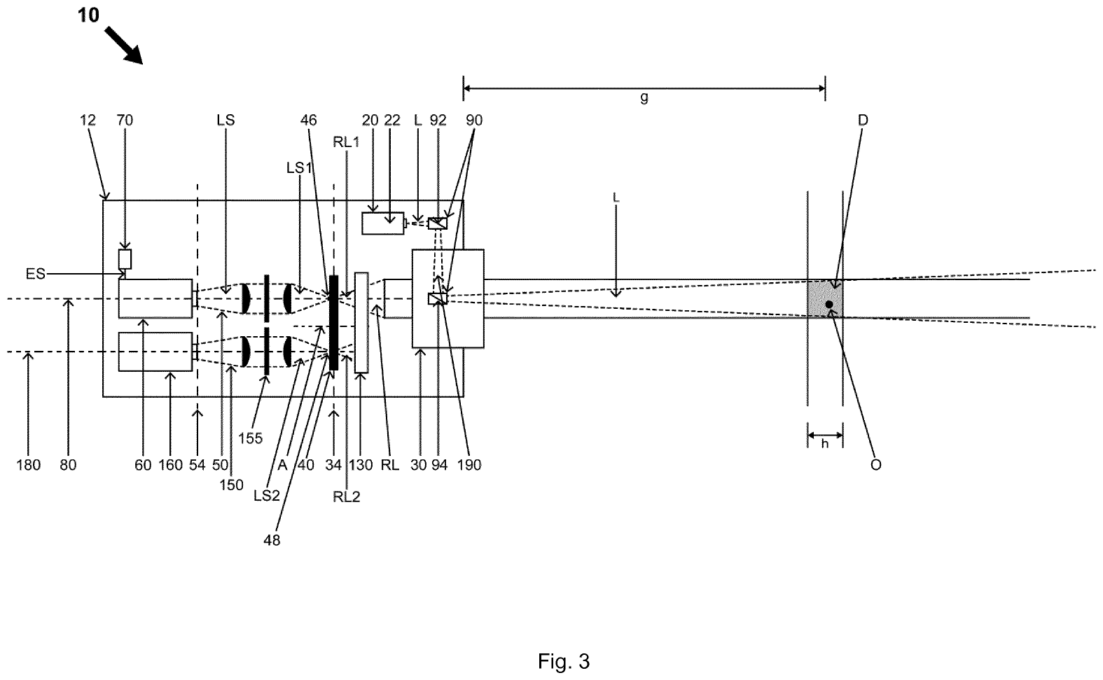

In order to be able likewise to calculate two horizontal velocity components of a two-dimensional velocity vector—in another embodiment of the apparatus according to the invention—the light RL reflected from the object O is split into two partial beams RL1 and RL2 by a beam splitter 130 and is imaged onto the modulator 40 by the lens 30. In this case—as is furthermore shown in FIG. 3—each partial beam RL1, RL2 is imaged onto a dedicated region 46, 48 on the modulator 40, which do not overlap. The modulator 40 is thus traversed by the two partial beams RL1, RL2 on two parallel, spatially separated beam paths. Here, too, the modulator 40 can be arranged in a fixedly mounted manner or can rotate uniformly about its center axis.

The receiving optical unit 50 and the light detector 60 are arranged in the first beam path. A second receiving optical unit 150 and a second light detector 160 are arranged in the second beam path.

A filter unit 155, an iris stop (not shown) and a shutter (likewise not illustrated) can also be arranged between the receiving optical units 50, 150, which preferably have a system of lens elements. The shutter can be closed as soon as the incident radiation exceeds a predefined intensity threshold value. These components are not illustrated, for reasons of clarity.

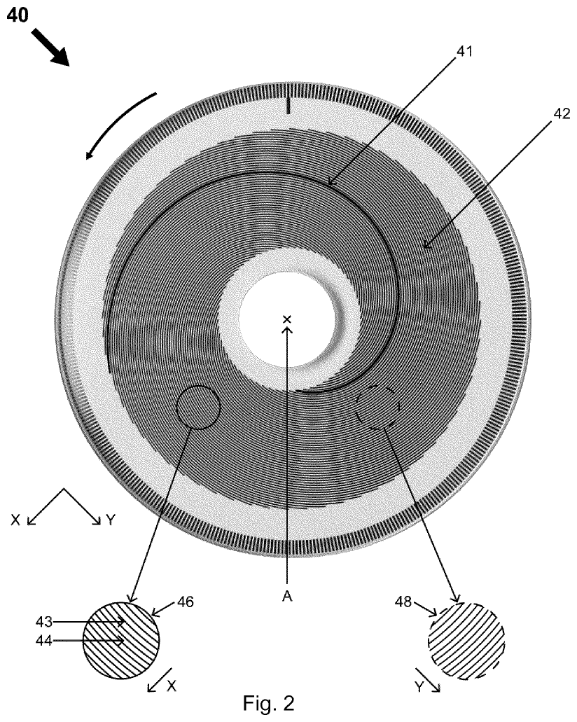

The modulator 40 shown in FIG. 2 is additionally mounted rotatably about an axis A and driven by a motor (not illustrated).

It is evident in FIG. 2 that the modulator 40 is embodied as a circular, quasi-radially symmetrical grating mask (referred to as mask hereinafter), which rotates at a rotational frequency n, which can be set in a defined manner, about an axis of rotation running perpendicularly through its center point.

The mask has a pattern 42 of Nsₚ=64 identical spiral lines 41 in the form of Archimedean spirals, which run from the inner region of the mask to the outer side thereof. The lines 41 are embodied as opaque regions 43. Situated between two adjacent lines 43 in each case is a non-opaque region 44 having the same width as the opaque regions 43. This gives rise to a grating pattern formed by the lines 43, 44. The basic grating constant of said grating is given by the distance between the centers of two adjacent spiral lines 43. It is G₀=0.25 mm, for example. For visualization purposes, in FIG. 2 an arbitrarily chosen Archimedean spiral 41 is highlighted by having been drawn with greater line thickness. By way of example, the external diameter of the pattern 42 is 5 cm, and the internal diameter is 1 cm.

In order that the conditions (15) and (16) are always reliably met, the following procedure is suitable:

A maximum wind velocity vₘₐₓ is defined which is intended to be measurable unambiguously by the LiDAR system 10. For the zero frequency f₀ this then yields the condition

f₀>v_{max/G} (19)

In the present case, this results in a suitable zero frequency f₀=8000 Hz, which is realized by virtue of the modulator 40, which has 64 spiral lines, rotating at a rotational frequency n=125 Hz.

The modulator 40 rotates in the counterclockwise direction, as indicated by the arrow at the top left in FIG. 2, such that the spiral lines 41 move from the outer region inward. The light RL reflected from the object O is directed by the lens 30 through that region of the mask pattern 42 which is designated by 46, which region is illustrated again in an enlarged manner outside the mask. In the region 46, the spiral lines 41 move counter to the x-axis, wherein the reflected light RL is modulated with the zero frequency f₀=8000 Hz.

The modulated light RL, as is shown in FIG. 1, is focused as a sequence of light signals LS onto the light detector 60 via the receiving optical unit 50, which light detector can be protected against excessively intense exposure by the shutter (not shown). The light detector 60 converts the light signals LS into electrical signals ES, amplifies them as necessary and forwards them to the evaluation unit synchronized with the laser.

The evaluation unit ascertains the frequency fₓ of the signal component that is caused by backscattering objects O, e.g. aerosol particles, in the detection region D at the distance g=300 m and calculates the transverse velocity component vₓ therefrom in accordance with equation (9).

In order also to be able to measure the transverse velocity component v_{y} of the wind velocity, the reflected light RL is split by the beam splitter 130 and the second partial beam RL2 of the reflected light RL is directed through a region 48 offset by 90° relative to the region 46 on the mask, where it is modulated by the spiral lines 41, which here move counter to the y-direction.

The signal modulated in this way is then focused onto the second light detector 160 by the second receiving optical unit 150 and is registered and analyzed in the evaluation unit in the same way as was described for the x-component.

An overview of the expected frequencies for a velocity of 2 m/s and different measurement distances g is given in Table 3.

TABLE 3
Relationship between measurement distance,
magnification, grating constant and frequency

| Measurement | Magnification | Grating | Frequency |
|---|---|---|---|
| distance g [m] | V | constant G [mm] | for 2 m/s |
| 15 | 2.8 | 0.71 | 10820.56 |
| 30 | 6.7 | 1.67 | 9198.93 |
| 45 | 10.5 | 2.63 | 8761.26 |
| 60 | 14.3 | 3.59 | 8557.68 |
| 75 | 18.2 | 4.55 | 8440.01 |
| 90 | 22.0 | 5.50 | 8363.34 |
| 105 | 25.9 | 6.46 | 8309.43 |
| 120 | 29.7 | 7.42 | 8269.45 |
| 135 | 33.5 | 8.38 | 8238.61 |
| 150 | 37.4 | 9.34 | 8214.11 |
| 165 | 41.2 | 10.30 | 8194.18 |
| 180 | 45.0 | 11.26 | 8177.64 |
| 195 | 48.9 | 12.22 | 8163.69 |
| 210 | 52.7 | 13.18 | 8151.78 |
| 225 | 56.5 | 14.14 | 8141.48 |
| 240 | 60.4 | 15.10 | 8132.49 |
| 255 | 64.2 | 16.05 | 8124.58 |
| 270 | 68.1 | 17.01 | 8117.55 |
| 285 | 71.9 | 17.97 | 8111.28 |
| 300 | 75.7 | 18.93 | 8105.64 |

The receiving optical unit 50 always ensures that the backscattered light modulated by the modulator 40 is focused onto the light detector 60. It is preferably embodied as a system of lens elements.

Table 4 summarizes again those parameters of the above-explained measurement which determine the backscattering signal RL. Table 4 shows that the backscattering signal consists only of a few photons. The scanning region, given by the region of the depth of field of 1.83 m at the measurement distance g=300 m, i.e. the height range 300 m±0.92 m, is traversed by the laser signal within 6.1 ns and excites an aerosol particle O present in this region to backscattering. The same time period of 6.1 ns should be taken into account for the backscattering, with the result that the backscattering signal should be detected in a time interval with a length of 12.2 ns. In this time period to be assigned to the region of the depth of field (1.83 m), on average 58.1 photons are registered, which corresponds to 3.2 photons/ns. This very weak backscattering signal is converted into an electrical signal by the light detector 60, for example a photomultiplier, is amplified and is fed to the evaluation unit.

TABLE 4
Values of the parameters of the backscattering signal

| Parameter | Value | Unit |
|---|---|---|
| Transmission losses ηₜ | 0.8 | |
| Reception losses ηₓ | 0.7 | |
| Pulse energy Eₓ | 30 | μJ |
| Pulse repetition frequency PRF | 50 | kHz |
| Average laser power P_{average} | 1.5 | W |
| Overlap function O(g) | 0.5 | |
| Measurement distance g | 300 | m |
| Atmospheric transmission losses T | 95.1 | % |
| Backscattering coefficient β | 10⁻⁶ | m⁻¹sr⁻¹ |
| Aperture D | 35 | cm |
| Area of the aperture A_{R} | 962.1 | cm² |
| Power P_{S}gathered via the aperture | 1217.63 | pW |
| Wavelength λ | 532 | nm |
| Photon flux | 3.2 | Photons/ns |
| Scanning region | 1.83 | m |
| Photons in the scanning region | 39.54 | Photons/1.83 m |

By way of example, within the apparatus 10 it is possible to use a light source 20 in the form of a monochromatic pulsed laser 22 having a wavelength of λ=532 nm, which allows particularly simple adjustment of the LiDAR system.

The pulsed laser 22 additionally has the following parameters coordinated with a desired maximum measurement distance of g=300 m and with a chosen lens:
Pulse repetition frequency (repetition rate) of the laser: PRF=50 kHz,
Pulse duration of the laser pulses: ΘP=800 ps,
Average laser power: Paverage=1.5 W,
Energy per laser pulse: Ex=30 μJ

Between the pulse duration ΘP and the vertical spatial resolution s there is the relationship s=½·c·ΘP. The factor ½ arises because the measurement distance g is traversed twice, by the laser pulse and by the far weaker backscattering pulse that is registered.

The chosen pulse duration ΘP=800 ps ensures a vertical spatial resolution s of 12 cm, such that the predefined vertical spatial resolution of 15 cm is attained. The setting to the measurement distance g by way of the pulse propagation time tP: g=½·c·tP is effected in a corresponding manner.

With the apparatus 10 it is thus possible for example to measure wind velocities of up to 20 m/s in a plurality of detection regions situated at measurement distances (heights) g of between 50 m and 300 m.

It is evident that the apparatus 10 according to the invention has distinct advantages over the systems and apparatuses from the prior art:
The apparatus 10 has a distinctly lower energy loss of the light beam compared to EP 2 062 058 B1.
The construction of the transmission path 190 and that of the receiver path 80 are distinctly simplified.
The emitted light beam L does not have to be shaped and adapted by means of a plurality of successive lens elements. This results in a distinctly more robust system.
Interference generated by the mask 40 does not arise.
The mask signal can be modulated on any received light reflection.
The focal length of the lens 30 is adaptable, whereby the magnification of the grating can be controlled.
The detection is simplified by virtue of the higher radiation power.
The system 10 is easier to reproduce because the calibration of the receiving optical unit 50 is associated with significantly less complexity in comparison with the transmitting optical unit. As a result, the production of the apparatus is more economic in comparison with the conventional apparatuses.
By virtue of the greater option for parameterization, the system 10 can be designed rapidly and simply for planned measurement distances.
The size of the detection region D is defined by the optics and can therefore be given very small dimensioning even at a large distance.

It is furthermore evident that the invention relates to an apparatus 10 for ascertaining a velocity component vₓ, v_{y} of an object O that moves in a detection region D at a measurement distance g relative to the apparatus 10 and reflects light L originating from a light source 20, wherein the object O generates reflected light RL that emanates from the detection region D. For this purpose, the apparatus 10 has a lens 30, a modulator 40, a receiving optical unit 50 and a light detector 60, wherein the lens 30 captures the reflected light RL generated by the object O in the detection region D and images it onto the modulator 40, wherein the modulator 40 modulates the reflected light RL into a sequence of light signals LS, wherein the receiving optical unit 50 images the sequence of light signals LS generated by the modulator 40 onto the light detector 60, and wherein the light detector 60 converts the sequence of light signals LS into a sequence of electronic signals ES. The apparatus furthermore has an interface 70, which forwards the sequence of electronic signals ES generated by the light detector 60 to an evaluation unit. With this apparatus 10, which forms a LiDAR system for the remote measurement of at least one transverse velocity component of an object O in a three-dimensional space, the direction of the measurement is freely selectable. In particular, the apparatus 10 allows the measurement of the velocity of drifting objects concomitantly moved in fluids, thereby enabling a ground-based measurement of the wind velocity at different heights with high spatial and temporal resolution and also a non-contact measurement of the flow velocity in liquids. The velocity of objects 0 that move independently of fluids can likewise be measured.

The invention is not restricted to any of the embodiments mentioned above. By way of example, the modulator 40 is preferably provided with a pattern 42 of Archimedean spirals 41. However, it is also possible to use other patterns and structures, e.g. other types of spirals or grating structures.

Symbols

A_{R} Area of the aperture D of the lens: A_{R}=(¼)πD²

b Opening diameter of the iris stop

bₙₒₚ Width of the non-opaque lines of the modulator

bₒₚ Width of the opaque lines of the modulator

c Velocity of light in the respective medium

d Diameter of the laser beam (as a function of the measurement distance g)

D Aperture of the lens

d_{f} Depth of field: Distance with respect to the far point

dₙ Depth of field: Distance with respect to the near point

d₀ Diameter of the emergent laser beam after shaping

d_{Obj} Diameter of the detection region captured by the lens

Eₓ Pulse energy

f₀ Frequency at which the grating lines of the modulator move (zero frequency)

f Focal length of the lens

fₓ Measured frequency of the backscattering signal in the x-direction

f_{y} Measured frequency of the backscattering signal in the y-direction

Δfₓ Frequency shift of fₓ relative to the zero frequency

Δf_{y} Frequency shift of f_{y} relative to the zero frequency

g Measurement distance from the lens to the detection region

G Grating constant of the image of the modulator projected back into the detection region

G₀ Basic grating constant of the modulator

h Depth of field in the detection region

n Rotational frequency of the modulator

N_{Sp} Number of spirals of the modulator

O(g) Overlap function

P_{average} Average power of the laser

P_{S} Gathered power of the backscattering signal via the aperture d of the lens

PRF Pulse repetition frequency (repetition rate) of the laser

s Vertical spatial resolution

tₚ Pulse propagation time

T Atmospheric transmission losses

v Velocity vector of an object in two- or three-dimensional space

|v| Magnitude of the velocity v of an object

vₓ, v_{y} Velocity components of an object transversely with respect to the measurement direction (transverse velocity components)

v_{z} Velocity component of an object in the measurement direction (longitudinal velocity component)

vₘₐₓ Maximum value of the velocity to be measured

V Magnification factor G/G₀

α Direction of the velocity v of an object

β Backscattering coefficient

ηₜ Transmission losses

ηₓ Reception losses

λ Wavelength of the light source

φ Divergence angle of the shaped laser beam

Θ_{P} Pulse duration of the laser pulses (when a pulsed laser is used)

### REFERENCE SIGNS

| | |
|---|---|
| 10 | Apparatus |
| 12 | Housing |
| 20 | Light source |
| 22 | Laser |
| 30 | Lens |
| 34 | Focal plane |
| 40 | Modulator |
| 41 | Spiral line |
| 42 | Pattern |
| 43 | Opaque line/region |
| 44 | Non-opaque line/region |
| 46 | First region of the modulator |
| 48 | Second region of the modulator |
| 50 | Receiving optical unit |
| 54 | Focal plane |
| 60 | Light detector |
| 70 | Interface |
| 80 | Optical receiver path |
| 90 | Mirror optical unit |
| 92 | First deflection mirror |
| 94 | Second deflection mirror |
| 130 | Beam splitter |
| 150 | Second receiving optical unit |
| 155 | Filter unit |
| 160 | Second light detector |
| 180 | Second optical receiver path |
| 190 | Optical transmission path |
| A | Axis |
| D | Detection region |
| ES | Electronic signals |
| L | Light |
| LS | Light signals |
| LS1 | Light signals |
| LS2 | Light signals |
| O | Object |
| RL | Reflected light |
| RL1 | Partial beam |
| RL2 | Partial beam |

1. An apparatus for ascertaining a velocity component of an object that moves in a detection region at a measurement distance relative to the apparatus and reflects light originating from a light source, wherein the object generates reflected light that emanates from the detection region,
a) comprising a lens, a modulator, a receiving optical unit and a light detector,
b) wherein the lens captures the reflected light generated by the object in the detection region and images it onto the modulator,
c) wherein the modulator modulates the reflected light into a sequence of light signals,
d) wherein the receiving optical unit images the sequence of light signals generated by the modulator onto the light detector, and
e) wherein the light detector converts the sequence of light signals into a sequence of electronic signals, and
f) comprising an interface, which forwards the sequence of electronic signals generated by the light detector to an evaluation unit.

2. The apparatus as claimed in claim 1, characterized in that the lens, the modulator, the receiving optical unit and the light detector are arranged on an optical receiver path, wherein the receiver path is embodied within the apparatus.

3. The apparatus as claimed in claim 1, characterized in that the lens images the detection region with a defined depth of field on the modulator.

4. The apparatus as claimed in claim 1, characterized in that the lens images the light reflected from the object onto a defined region of the modulator.

5. The apparatus as claimed in claim 1, characterized in that the modulator is provided with a pattern of alternating opaque and non-opaque lines.

6. The apparatus as claimed in claim 5, characterized in that the opaque and non-opaque lines are embodied in the form of Archimedean spirals.

7. The apparatus as claimed in claim 1, characterized in that the modulator is fixed within the apparatus or is mounted rotatably about an axis.

8. The apparatus as claimed in, characterized in that the light detector is arranged in a focal plane of the receiving optical unit.

9. The apparatus as claimed in claim 1, characterized in that a beam splitter is arranged between the lens and the modulator and splits the light reflected from the object into two partial beams, wherein the lens images the partial beams generated by the beam splitter into a first region and into a second region of the modulator, wherein the regions do not overlap.

10. The apparatus as claimed in claim 9, characterized in that the modulator modules the partial beams in a first sequence of light signals and a second sequence of light signals, wherein the receiving optical unit images the first sequence of the first light signals generated by the first region of the modulator onto the light detector, and in that a second receiving optical unit images the second sequence of the second light signals generated by the second region of the modulator onto a second light detector.

11. The apparatus as claimed in claim 10, characterized in that the second receiving optical unit and the second light detector are arranged on a second optical receiver path, wherein the receiver path and the second receiver path are arranged parallel.

12. The apparatus as claimed in claim 1, characterized in that the light source for the light to be reflected is a laser or an incoherent light source.

13. The apparatus as claimed in claim 1, characterized in that a mirror optical unit is provided, which directs the light emanating from the light source in the direction of the detection region and into the optical axis of the lens.

14. The apparatus as claimed in claim 13, characterized in that the light source, the imaging optical unit and the mirror optical unit lie on an optical transmission path, wherein the light source, the imaging optical unit and/or the mirror optical unit are/is arranged within the apparatus.

15. The apparatus as claimed in any of claim 1, characterized in that an evaluation unit calculates the velocity components of the object from the sequences of the electronic signals.
